(19) United States
(12) Patent Application Publication
(10) Pub. No.: US 2026/0021835 A1
(43) Pub. Date: Jan. 22, 2026

(54) SYSTEMS AND METHODS TO EXTEND DEAD RECKONING USING WAYSIDE EQUIPMENT

(71) Applicant: Siemens Mobility, Inc., New York, NY (US)

(72) Inventor: Brian D. Lawry, Murrysville, PA (US)

(73) Assignee: Siemens Mobility, Inc., New York, NY (US)

(21) Appl. No.: 18/775,005

(22) Filed: Jul. 17, 2024

(51) Int. Cl. B61L 25/02; G01C 21/16

(52) U.S. Cl. CPC B61L 25/025; B61L 2205/04; G01C 21/165

(57) ABSTRACT

A system to extend dead reckoning includes multiple input devices including primary input devices and secondary input devices, a location system configured to receive position information from the multiple input devices and to determine a location of a train, vehicle or car, the location system including a calculation module that is configured to, through operation of a processor, receive position information from the primary input devices, receive identification information from the secondary input devices and obtain position information of the secondary input devices based on the received identification information, and determine the location of the train with the position information of the primary input devices or determine the location of the train including dead reckoning with the position information of the secondary input devices when the primary input devices are unavailable or provide insufficient position information.

### TECHNICAL FIELD

Aspects of the present disclosure generally relate to systems and methods to extend dead reckoning using wayside equipment, for example in connection with a train, vehicle, or car.

### BACKGROUND ART

Determining and controlling movements of trains in a modern environment is a complex process. Collisions with other trains must be avoided and regulations in areas such as grade crossings must be complied with. Train control systems such as Positive Train Control (PTC), Automatic Train Control (ATC), etc. increase performance of trains and railroads in terms of for example speed, reliability, and safety.

PTC is a system designed to prevent train-to-train collisions, derailments caused by excessive speeds, unauthorized train movements in work zones, and the movement of trains through switches left in a wrong position. PTC networks enable real-time information sharing between trains, rail wayside devices, and back-office applications, regarding train movement, speed restrictions, train position and speed, and the state of signaling and switching devices.

Existing train control systems use different devices and components to determine a location of a train. For example, a PTC system uses a track database and Global Positioning System (GPS) receivers providing position, combined with an axle tachometer to determine a location of the train. In another example, a transponder-based solution, such as Advanced Civil Speed Enforcement System (ACSES), e utilizing balises (transponders) installed in train tracks, coded track circuits, digital radio combined with an axle tachometer to determine a location of the train.

Under certain circumstances, the known location methods are unable to provide position information. Then, to determine the location, the systems use alternative methods and/or devices that typically accumulate errors which then need to be corrected. For example, in case of the PTC system, instead of using GPS based position information (which is the known location method), the system uses axle tachometer(s) to accumulate a distance travelled from a last known location, which in combination with speed is used to determine the location. This is known as dead reckoning. Due to sensor tolerances of the axle tachometer, the system may detect more distance, or less distance that the actual distance travelled, for a variety of reasons. This discrepancy creates a range where the actual distance travelled is predicted to be somewhere within the range. This range is known as the range of error. As time goes on, the range of error becomes larger and larger. Eventually, the range of error is so large that the system becomes unusable for meaningful location determination.

### SUMMARY

Briefly described, aspects of the present disclosure generally relate to systems and methods to extend dead reckoning using wayside equipment, for example in connection with a train, vehicle, or car.

Specifically, a first aspect of the present disclosure provides a system to extend dead reckoning, the system comprising multiple input devices including primary input devices and secondary input devices, a location system configured to determine a location of a train, the location system comprising a calculation module that is configured to, through operation of at least one processor, receive position information from the primary input devices, receive identification information from the secondary input devices and obtain position information of the secondary input devices based on the received identification information, and determine the location of the train with the position information of the primary input devices or the position information of the secondary input devices when the primary input devices are unavailable or provide insufficient position information.

A second aspect of the present disclosure provides a method to extend dead reckoning, the method comprising collecting position information and/or identification information from multiple input devices, determining whether position information of a primary input device is available and adequate, determining a location of a train with the position information of the primary input device when available and adequate, and when the position information of the primary input device is unavailable or inadequate, determining the location of the train with information from a secondary input device, wherein the secondary input device is a railroad infrastructure device.

### BRIEF DESCRIPTION OF THE DRAWINGS

FIG. 1 illustrates a diagram of a known train control system in accordance with an exemplary embodiment of the present disclosure.

FIG. 2 illustrates a diagram of a first embodiment of a system to extend dead reckoning using wayside equipment in accordance with an exemplary embodiment of the present disclosure.

FIG. 3 illustrates a diagram of a second embodiment of a system to extend dead reckoning using wayside equipment in accordance with an exemplary embodiment of the present disclosure.

FIG. 4 illustrates a railroad track including calculation samples of locations of a train based on dead reckoning including different ranges of error.

FIG. 5 illustrates a flow chart of a method to extend dead reckoning for a train in accordance with an exemplary embodiment of the present disclosure.

### DETAILED DESCRIPTION

To facilitate an understanding of embodiments, principles, and features of the present disclosure, they are explained hereinafter with reference to implementation in illustrative embodiments. They are described in the context of systems and methods to extend dead reckoning using wayside equipment, specifically in connection with a train. The components and materials described hereinafter as making up the various embodiments are intended to be illustrative and not restrictive. Many suitable components and materials that would perform the same or a similar function as the materials described herein are intended to be embraced within the scope of embodiments of the present disclosure. Like reference symbols in the various drawings indicate like elements.

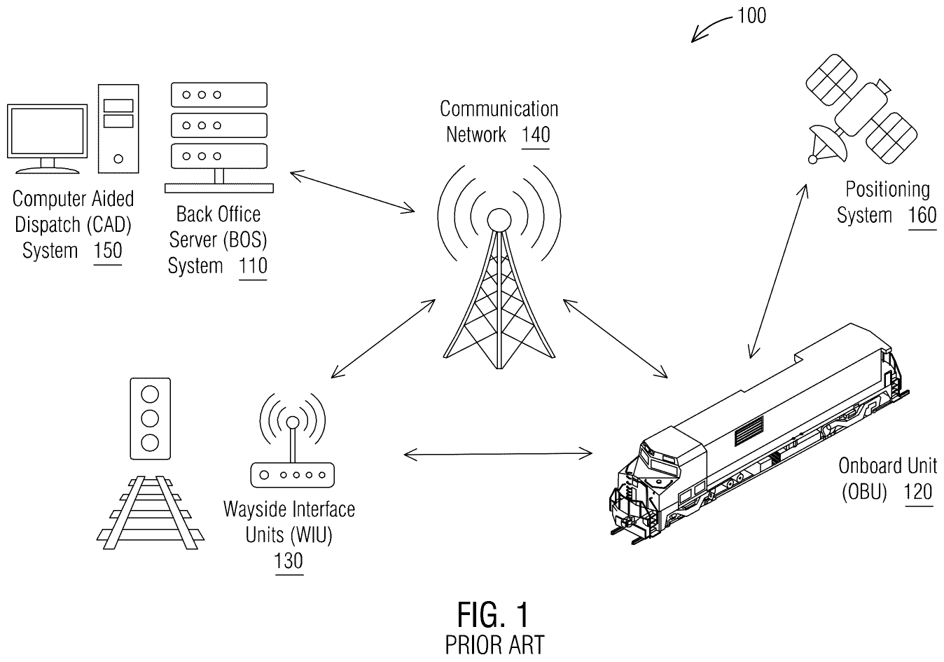

FIG. 1 illustrates a diagram of a known train control system 100 in accordance with an exemplary embodiment of the present disclosure. In an example, the train control system 100 is configured as PTC system. As noted earlier, PTC is a system designed to prevent train-to-train collisions, derailments caused by excessive speeds, unauthorized train movements in work zones, and the movement of trains through switches left in the wrong position.

In general, PTC system 100 comprises back-office server system 110, herein also referred to as BOS system 110, an onboard unit 120 installed and operating in a locomotive of a train, herein also referred to as OBU 120, and a system of wayside interface units 130, herein also referred to as WIUs 130. Further, system 100 comprises a communication network 140 configured to interface with the BOS system 110, the OBU 120, and the WIUs 130.

The PTC system 100 enables real-time information sharing between the BOS system 110, the OBUs 120 of trains, and WIUs 130, regarding train movement, speed restrictions, train position and speed, and the state of signal and switch devices etc.

The BOS system 110 is a storehouse for speed restrictions, track geometry and wayside signaling configuration databases. The BOS system 110 is operably coupled to a computer aided dispatch system 150, herein also referred to as CAD system 150. The CAD system 150 can be integrated in the BOS system 110. The CAD system 150 is configured to display and dispatch information/data, i. e. messages, to other components or sub-systems, such as the BOS system 110. In an example, the CAD system 150 comprises a human-machine-interface (HMI), e. g. computer and screen, and can be configured to display information on the screen, such as information/data collected by the WIUs 130. Further, the CAD system 150 can be configured such that information/data can be entered, for example manually by an operator, for further processing by the CAD system 150 and/or the BOS system 110.

The OBU 120 monitors and controls train movement, for example if train operator (engineer) fails to respond to (audible) warnings. The OBU 120 is in communication with a positioning system 160 to determine the position of the train. The positioning system 160 can be for example the Global Positioning System, known as GPS, and the OBU 120 can comprise a GPS receiver.

The WIUs 130 are crucial components for collecting, processing, and transmitting data from wayside devices such as track circuits and signals to the BOS system 110 and/or OBU 120, via communication network 140. Such wayside information can include for example switch positions, signal states etc.

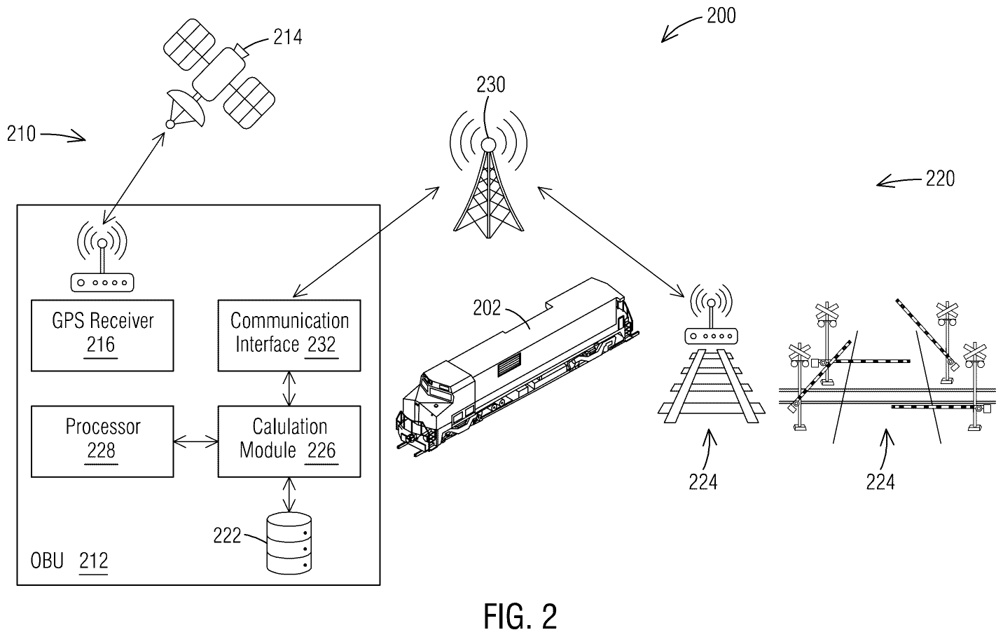

FIG. 2 illustrates a diagram of a first embodiment of a system 200 to extend dead reckoning using wayside equipment in accordance with an exemplary embodiment of the present disclosure.

As noted earlier, under certain circumstances, the known location methods are unable to provide position information and/or determine locations. Then, to determine the location, the systems use alternative methods and/or devices that typically accumulate errors which need to be corrected, known as dead reckoning. However, there is no current way to provide more accurate position information for the dead reckoning method to allow the system to recover from large error ranges when performing the dead reckoning.

In the example of the PTC system 100 as shown in FIG. 1, track database (BOS system 110), GPS system 160 and GPS receivers in the OBU 120 are used to determine a location of the train. The technical problem that arises with the GPS based system for location determination is that GPS receivers may have extended periods of time when they are unable to provide a position. These outages may be due to interference, foliage, tunnels, or the GPS system may be disabled. The system then performs dead reckoning to determine location, primarily based on axle tachometer(s) to accumulate the distance traveled from the last known location. An option to recover from a large error range is to obtain new position information that is more accurate than the dead reckoning range. This usually occurs when the GPS position becomes known again.

With respect to an ACSES system, which uses balises (transponders) instead of the GPS system, the train travels between the balises and uses dead reckoning to determine the train location. The more balises are installed in train tracks, the more accurate locations of the train can be obtained. However, the cost of balises is prohibitive for the industry to put them everywhere.

In accordance with an embodiment of the present disclosure, the system 200 to extend dead reckoning comprises a location system and multiple input devices 210, 220. The multiple input devices include primary devices 210 and secondary devices 220. The primary devices 210 comprise most accurate devices adequate for determining the location of the train 202.

In an example, the primary input devices 210 comprise a Global Positioning System (GPS) receiver 216 to determine location of the train 202 in communication with a Global Positioning System (GPS) 214. In another example, the primary input devices 210 comprise transponders, such as balises in an ACSES system, to determine location of the train 202.

The secondary input devices 220 comprise devices and/or methods to extend dead reckoning, for example when the primary input device 210 are insufficient or unavailable to determine the location of the train 202. The secondary input devices 220 include, but are not limited to, different devices of railroad infrastructure equipment 224, such as track circuits, signals, grade crossings, wayside devices, cameras, motion detectors, speed sensors, LiDAR sensors, etc. Axle tachometers, if available, may also be considered secondary input devices 220.

The system 200 further comprises a database 222 that stores position information of the secondary input devices 220, e. g. railroad infrastructure equipment 224. The system 200 further comprises a calculation module 226 that is configured to, through operation of at least one processor 228, to receive an input from a device of the railroad infrastructure equipment 224, obtain position information of the device from the database 222, and determine a location of the train 202 based on the position information of the device.

In another example, position information of the secondary input devices 220 (infrastructure equipment 224) may be individually stored by each infrastructure device 224, instead of in the database 222. In this case, the database 222 is considered a local device database.

Position information of the infrastructure devices 224 is specific, for example Latitude/Longitude/Altitude (Lat/Long/Alt), or Lat/Long/Alt/Radius, or a geofence or similar. Similarly, the location calculated by the system 200 via dead reckoning, can be Lat/Long/Alt, or Lat/Long/Alt/Radius, or a geofence or similar. The position information includes some amount of error range, which can then be used to improve or correct the error range of the train location.

The system 200 is configured to determine the location of the train 202 based on the location of the secondary input devices 220 when the primary input devices 210, such as GPS 214 or transponders, are unavailable or provide insufficient data. In these instances, the system 200 is configured to perform dead reckoning to correct the location of the train 202 and/or reduce the range of error under conditions where the error has grown large. Dead reckoning is the process of calculating a current position (location) of a moving object, e. g. train 202, by using a previously determined location, e. g. last known position of train using GPS 214, and incorporating estimates of speed, heading (or direction or course) and elapsed time. Dead reckoning includes a range of error, due to calculation and equipment tolerances.

The secondary input devices 220 are used to reduce the range of error and/or correct the location of the train 202. More specifically, any railroad infrastructure device 224 that has an ability to detect presence of the train 202 by some means, combined with the database 222 (or other means) for sharing the device's location, may be used to correct or improve upon the range of error by providing updated location information.

In other words, the system 200 utilizes the multiple input devices 210, 220 and their respective position information as they are available and/or reliable. Are the primary input devices 210 available and reliable, the system 200 determines the location of the train 202 with the primary input devices 210. Are the primary input devices 210 not available or not adequate (reliable), the system 200 “switches” to utilizing information of the secondary input devices 220 to determine location of the train 202 by performing dead reckoning.

The system 200 as described with reference to FIG. 2, is configured such that the train 202, more specifically an on-board computer unit (OBU) 212 of the train 202, comprises and incorporates the database 222 and the calculation module 226 to perform dead reckoning and thus the location of the train 202. In this case, the train 202 performs all the calculations with respect to location. Thus, a communication link 230 interfaces with the OBU 212, via communication interface 232, and the railroad infrastructure equipment 224.

The communication link 230 supports wireless communication, for example wireless LAN (over Internet access point), cellular/mobile networks, radio technologies, or standard LTE (3G/4G/5G). In other examples, communication 230 between the infrastructure equipment 224 and the OBU 212 may be a beaconing method, or an audio and/or visual communication. For example, the infrastructure device 224 and/or the train 202 may have a visual indicator or audio indicator that can be read or received by the other participant of the communication. An infrastructure equipment device 224, for example a crossing gate may have a Quick Response (QR) code, including at least identification of the crossing gate, wherein the train 202 is equipped with a camera that can read the QR code when passing the crossing gate.

Via the communication link 230, there are different ways to communicate. For example, either the OBU 212 or the infrastructure equipment device 224 may start the communication. Communication may bi-directional or unidirectional. Unidirectional communication includes communication from the wayside equipment 224 to the OBU 212.

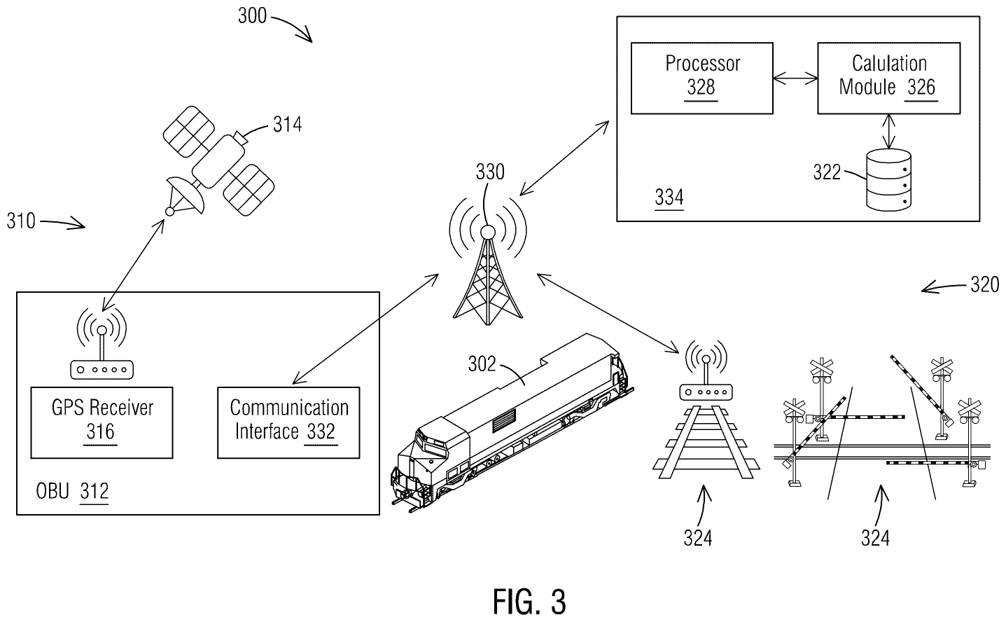

FIG. 3 illustrates a diagram of a second embodiment of a system 300 to extend dead reckoning using wayside equipment in accordance with an exemplary embodiment of the present disclosure.

The system 300 corresponds to certain elements of system 200 of FIG. 2, such as primary input devices 310, being embodied for examples as GPS 314 and GPS receiver 316, and secondary input devices 320 including railroad infrastructure equipment 324. Axle tachometers, if available, may also be considered secondary input devices 320.

The system 300 differs from system 200 in that the database 322 and the calculation module 326 for performing the location determinations including dead reckoning are not incorporated into the OBU 312, but are located remote to the train 302, for example in a remote computer system 334 other than the OBU 312.

The communication link 330 supports wireless communication, for example wireless LAN (over Internet access point), cellular/mobile networks, radio technologies, or standard LTE (3G/4G/5G), for example for data transmission between OBU 312 and remote computer system 334. In other examples, communication 330 between the infrastructure equipment 324 and the OBU 312 may be a beaconing method, or an audio or visual communication. For example, the infrastructure device 324 and/or the train 302 may have a visual indicator and/or audio indicator that can be read or received by the other participant of the communication. An infrastructure equipment device 324, for example a crossing gate may have a Quick Response (QR) code, including at least identification of the crossing gate, wherein the train 302 is equipped with a camera that can read the QR code when passing the crossing gate.

Via the communication link 330, there are different ways to communicate. For example, either the OBU 312 or the infrastructure equipment device 324 may start the communication. Communication may bi-directional or unidirectional. Unidirectional communication includes communication from the wayside equipment 324 to the OBU 312.

As shown in FIG. 2, the database 222 can be in the OBU 212 of the train 202 or can be a central database 322 located in the remote computer system 334 as shown in FIG. 3. In this case, the database 322 is a central database accessible by multiple trains or other vehicles.

As noted in connection with FIG. 2, position information of the secondary input devices (infrastructure equipment 324) may be individually stored by each infrastructure device 324, instead of in the database 322. In this case, the database 322 is considered a local device database.

Position information of the infrastructure devices 324 is specific, for example Latitude/Longitude/Altitude (Lat/Long/Alt), or Lat/Long/Alt/Radius, or a geofence or similar. Similarly, the location calculated by the system 200 or 300 via dead reckoning, can be Lat/Long/Alt, or Lat/Long/Alt/Radius, or a geofence or similar. The position information includes some amount of error range, which can then be used to improve or correct the error range of the train location.

With reference to FIG. 2 and FIG. 3, the devices of the infrastructure equipment 224, 324 are configured to transmit information or data to the OBU 212, 312 of the train 202, 302. The infrastructure equipment may send the information or data autonomously upon detection of the train 202, 302. The infrastructure equipment 224, 324 may send the information or data upon request of the train 202, 302, for example the train 202, 302, when travelling, detects or recognizes the wayside equipment 224, 324 and requests information.

In an example, an infrastructure device 224, 324 is configured to send a message including at least identification of the device to the OBU 212, 312. The message may also comprise a timestamp when the device has detected presence of the train 202, 302, i. e. when the train 202, 302 passed the device 224, 324. The time stamp may include a precise point in time or may include a range of time. In another example, the OBU 212, 312 may add the timestamp to the message of the device. In yet another example, the database 222, 322 may be considered a local database of each individual infrastructure device of equipment 224, 324. For example, an axle counter or grade crossing may have locally stored its position information. In this case, the message includes identification and position information, wherein the timestamp is included in the message or added to the message by the OBU 212, 312.

The message is used for correcting and improving the range of error of the dead reckoning performed by the system 200, 300. In the example of FIG. 2, in which the database 222 and calculation module 226 are incorporated into the OBU 212, the OBU 212 receives the message and performs the calculations. In the example of FIG. 3, where the database 322 and the calculation module 326 are remote to the train 302, the OBU 312 is configured to receive an original message from the infrastructure equipment 324 and transmit the message to the remote computer system 334 for further calculations. The original message either includes both identification and time stamp, or the original message only includes device identification, and the OBU 312 supplements the message with a timestamp and then transmits the message to the remote computer system 334. In this example, after the remote computer system 334 has performed location calculations, a message with the updated location is sent back to the OBU 312 for updating the location of the train 302. The time stamp may include a precise point in time or may include a range of time.

The railroad infrastructure equipment 224, 324 comprises devices selected from a wayside device, a grade crossing, a camera, a motion detector, a speed sensor, a lidar sensor. A wayside device includes axle counter, track circuits and signals. Regarding a grade crossing, an island circuit may be utilized for location determination.

Another example of a wayside device can be a “transition” from one track circuit to another. If a track circuit is occupied and an adjacent track circuit is unoccupied, and if at a point in time both track circuits are occupied, then it may be inferred that the train has crossed the location where these two track circuits meet. If the position this crossover is known, then it too can be used as position information to calculate the location of the train. In other words, there may be more than one wayside device used in combination to determine that a train was at a location at a point in time.

Further, in the case of a grade crossing or track circuit, there may be two possible locations. For example, in case of a 1-mile-long track circuit that goes east/west, it may not be possible to determine which end of the track circuit the train is at when the track circuit is detected as occupied. Thus, in another embodiment, the system 200, 300, for example the calculation module 226, 326, can be configured to determine the direction of the train using an algorithm and in combination for example with the PTC system, since the PTC system knows the direction of the train.

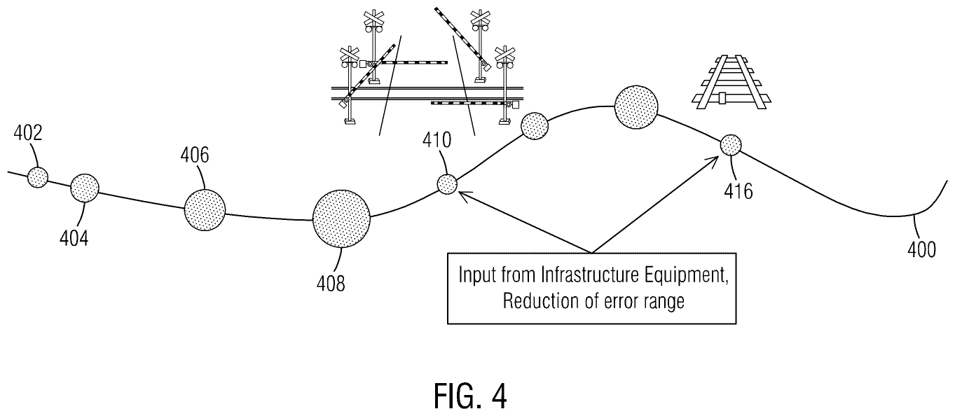

FIG. 4 illustrates a railroad track 400 including calculation samples of locations of a train based on dead reckoning including different ranges of error, performed by the system 200 or system 300. The track 400 shows different ranges of error, wherein a greater size of a circle corresponds to a greater inaccuracy/error range.

Location 402 may be the last known primary input device-based position (for example GPS based position) of the train 202, 302 travelling on the track 400. Location 402 is adequately accurate and thus the error range small. After that, the primary input device is not available, and the system performs dead reckoning utilizing the secondary input devices. As FIG. 4 shows, over time, the range of error increases, wherein location 404 has a greater error range than location 402, location 406 a greater error range than 404, and so on. At point 410, the system receives input from a crossing gate (secondary input device 224, 324), and uses this input to correct the range of error, and the location is more accurate again. The same happens at location 416, where the system receives input from an axle counter, a device installed at train tracks that detects and counts axles of the train travelling on the track 400.

In the example of the axle counter (see point 416) and with reference to FIG. 2, the axle counter can detect the presence of the train 202. Position information, such as Lat/Long/Alt, of the axle counter are entered and stored in the database 222. When the axle counter detects the train 202, it sends a message with identification to the OBU 212 of the train 202, wherein the OBU 212 records a time of when the message was received, looks up position information of the device in the database 222 and updates and improves, or resets, the range of error of the dead reckoning being performed by the OBU 212.

Another example is an island circuit of a grade crossing (see for example point 410). The grade crossing may have its position information stored locally at the crossing (local database 222). The crossing controller of the grade crossing detects the train 202 when crossing the island circuit and communicates the position information and the time of detection to the train 202.

In another example, the train 202 knows the identification of an upcoming grade crossing. The OBU 212 communicates to the crossing controller and commands the crossing controller to watch for the train 202 to cross. Further, the OBU 212 commands the controller to send a message to the OBU 212 with a timestamp when it detects the train 202 entering the island circuit. The position information of the grade crossing is in the database 222, stored in the OBU 212, wherein the location system adjusts the error range to the error range of the island circuit position.

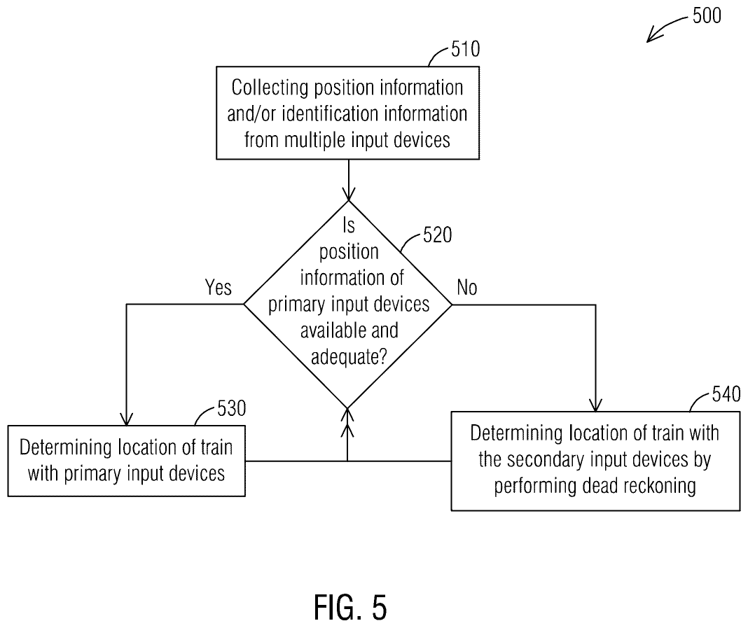

FIG. 5 illustrates a flow chart of a method 500 to extend dead reckoning in accordance with an exemplary embodiment of the present disclosure.

While the method 500 is described as a series of acts that are performed in a sequence, it is to be understood that the method 500 may not be limited by the order of the sequence. For instance, unless stated otherwise, some acts may occur in a different order than what is described herein. In addition, in some cases, an act may occur concurrently with another act. Furthermore, in some instances, not all acts may be required to implement a methodology described herein. The method is performed by a system as described herein, for example as described with reference to FIG. 2, FIG. 3, and FIG. 4.

The method 500 comprises act 510 of collecting position information and/or identification information from multiple input devices. In act 520, the method comprises determining whether position information of a primary input device is available and adequate. If the information of the primary input device is available and adequate (reliable), a location of a train is determined with the position information of the primary input device, as per act 530. When the position information of the primary input device is unavailable or inadequate, the method 500 comprises act 540 of determining the location of the train with information from a secondary input device, wherein the secondary input device is a railroad infrastructure wayside device. The determining of the location of the train with the secondary input device comprises performing dead reckoning. The determining of the location of the train with the primary input device includes a more accurate method and thus is preferred over the determining the location with the secondary input device. The location determination with the primary input devices is for example by utilizing GPS-based position information, or by utilizing transponder-based position information.

Further, as FIG. 5 shows, the method 500 includes checking, periodically or continually, whether the primary input device is available again. For example, after location of the train 202, 302 has been updated via infrastructure equipment 224, 324 and dead reckoning, the system/method performs act 520 again. If the outcome of act 520 is yes, the method 500 switches back to the preferred location determination.

The described systems and methods provide abilities for trains, vehicles, or cars, to determine their location when the respective preferred or designated location determination is unavailable. In the case of GPS-based solutions, there is no known way of recovering location besides recovering a GPS signal. Extended GPS outages are uncommon. When these occur, and the dead reckoning error range gets too large, PTC delocalizes which disables PTC. This is undesirable as PTC is viewed as a critical safety related system. The ability to correct errors in dead reckoning may allow trains to continue to run with PTC active longer. Transponder based or similar solutions require additional investment into device procurement and maintenance. The usage of existing railroad infrastructure equipment prevents investment and maintenance of additional track-based solutions.

1. A system to extend dead reckoning, the system comprising:
multiple input devices including primary input devices and secondary input devices,
a location system configured to determine a location of a train, the location system comprising a calculation module that is configured to, through operation of at least one processor,
receive position information from the primary input devices,
receive identification information from the secondary input devices and obtain position information of the secondary input devices based on the received identification information, and
determine the location of the train with the position information of the primary input devices or determine the location of the train with the position information of the secondary input devices when the primary input devices are unavailable or provide insufficient position information.

2. The system of claim 1,
wherein the primary input devices comprise a Global Positioning System (GPS) receiver in communication with a Global Positioning System (GPS), or transponders installed in railroad tracks.

3. The system of claim 1,
wherein the secondary input devices comprise railroad infrastructure equipment including a wayside device, a grade crossing, an island circuit, a camera, a motion detector, a speed sensor, a LiDAR sensor, an axle counter, a track circuit, and/or a signal.

4. The system of claim 3, further comprising:
a database storing the position information of the railroad infrastructure equipment.

5. The system of claim 4,
wherein the database and the calculation module are incorporated into an on-board computer unit (OBU) of the train.

6. The system of claim 4,
wherein the database and the calculation module are incorporated into a remote computer system other than an on-board computer unit (OBU) of the train.

7. The system of claim 6,
wherein the secondary input devices are configured to transmit a message to the OBU, and wherein the OBU further transmits the message to the remote computer system for determining the location of the train.

8. The system of claim 1,
further comprising a communication link between the secondary input devices and on-board computer unit (OBU) of the train, for communicating identification information and/or position information of the secondary input devices.

9. The system of claim 8,
wherein communication between the secondary input devices and the OBU is bidirectional or unidirectional.

10. The system of claim 8,
wherein communication between the secondary input devices and the OBU comprises an event-based method, a beaconing method, an audio method, or a visual method.

11. The system of claim 8,
wherein one of the secondary input devices comprises a Quick Response (QR) code including at least identification information of the secondary input device, and wherein the train is equipped with a camera configured to read the QR code when passing the respective secondary input device.

12. The system of claim 8,
wherein the secondary input devices are configured to store and transmit their identification information and/or their position information.

13. A method to extend dead reckoning, the method comprising:
collecting position information and/or identification information from multiple input devices,
determining whether position information of a primary input device is available and adequate,
determining a location of a train with the position information of the primary input device when available and adequate, and
when the position information of the primary input device is unavailable or inadequate, determining the location of the train with information from a secondary input device, wherein the secondary input device is a railroad infrastructure wayside device.

14. The method of claim 13,
wherein the determining of the location of the train with the position information of the secondary input devices includes dead reckoning, and further comprising correcting or improving a range of error of the dead reckoning utilizing the location of the secondary input devices.

15. The method of claim 13, further comprising:
communicating between the secondary input devices and on-board computer unit (OBU) of the train for transmitting identification information and/or position information of the secondary input devices, wherein communication between the secondary input devices and the OBU is bidirectional or unidirectional.

16. The method of claim 15,
wherein communication between the secondary input devices and the OBU comprises an event-based method, a beaconing method, an audio method, or a visual method.

17. The method of claim 15, further comprising:
reading a Quick Response (QR) code by the train when passing one of the secondary input devices comprising the QR code including at least identification information of the respective secondary input device.

18. The method of claim 15, further comprising:
transmitting, by the secondary input device, a message with identification information and a timestamp or range of time in response to detecting the train or in response to a command from the train to transmit the message.

19. The method of claim 11,
wherein, when the primary input devices provide sufficient data or are available again, determining the location of the train utilizing the primary input devices.

20. A non-transitory computer readable medium that comprises instructions, which, when executed by a computer, perform a method comprising:
collecting position information and/or identification information from multiple input devices,
determining whether position information of a primary input device is available and adequate,
determining a location of a train with the position information of the primary input device when available and adequate, and
when the position information of the primary input device is unavailable or inadequate, determining the location of the train with information from a secondary input device, wherein the secondary input device is a railroad infrastructure wayside device.
